(19) United States
(12) Patent Application Publication
(10) Pub. No.: US 2013/0219922 A1
(43) Pub. Date: Aug. 29, 2013

(54) GEARED GAS TURBINE ENGINE WITH REDUCED FAN NOISE

(71) Applicants: Jonathan Gilson, W. Hartford, CT (US); Bruce L. Morin, Springfield, MA (US); Ramons A. Reba, South Windsor, CT (US); David A. Topol, West Hartford, CT (US); Wesley K. Lord, South Glastonbury, CT (US)

(72) Inventors: Jonathan Gilson, W. Hartford, CT (US); Bruce L. Morin, Springfield, MA (US); Ramons A. Reba, South Windsor, CT (US); David A. Topol, West Hartford, CT (US); Wesley K. Lord, South Glastonbury, CT (US)

(21) Appl. No.: 13/408,382

(22) Filed: Feb. 29, 2012

(51) Int. Cl. F01D 9/04; F02C 3/04

(52) U.S. Cl. 60/805; 415/208.2

(57) ABSTRACT

A fan section for a gas turbine engine has a fan rotor with a plurality of fan blades. A plurality of exit guide vanes are positioned to be downstream of the fan rotor. The fan rotor is driven through a gear reduction relative to a turbine section. The exit guide vanes are desired to address resultant sound from interaction of wakes from the fan blades across exit guide vanes. A gas turbine engine incorporating a fan section is also disclosed.

### BACKGROUND

This application relates to a gas turbine engine having a gear reduction driving a fan, and wherein exit guide vanes for the fan are provided with noise reduction features.

Gas turbine engines are known, and typically include a fan delivering air into a compressor section. The air is compressed and passed into a combustion section where it is mixed with fuel and ignited. Products of this combustion pass downstream over turbine rotors, and the turbine rotors are driven to rotate the compressor and fan.

Traditionally, a low pressure turbine rotor drives a low pressure compressor section and the fan rotor at the identical speed. More recently, a gear reduction has been provided such that the fan can be rotated at a reduced rate.

With this provision of a gear, the diameter of the fan may be increased dramatically to achieve a number of operational benefits. Increasing fan diameter, however, implies that the fan noise sources will dominate the total engine noise signature.

A major fan noise source is caused by rotating turbulent wakes shed from the fan interacting with the stationary guide vanes. The stationary guide vanes, or fan exit guide vanes are positioned downstream of the fan. A discrete, or tonal, noise component of this interaction is caused by the specific number of fan wakes interacting with the specific number of vanes in a periodic fashion. A random, or broadband, noise source is generated from the nature of turbulence inside each fan wake interacting with each guide vane.

At a given engine power condition, if the ratio of guide vanes to fan blades is lower than a critical value, the tonal noise is said to be “cut-on” and may propagate to an outside observer location, e.g. an observer location either in the aircraft or on the ground. If the ratio of guide vanes to fan blades is above the critical value, however, the tonal noise is said to be “cut-off.” Total engine noise may be dominated by tonal and/or broadband noise sources resulting from the fan wake/guide vane interaction.

Traditional acoustic design addresses tonal noise by targeting a cut-off vane count for subsonic fan tip speeds. The broadband noise, however, may require a lower vane count to decrease the number of turbulent sources. For a given number of fan blades, lowering the vane count below a critical value creates a cut-on condition and thus higher tone noise levels.

Thus, there is a tradeoff between addressing the two types of noise.

While cut-off vane counts have been utilized in the past, they have not been known in an engine including the above-mentioned gear reduction.

### SUMMARY

In a featured embodiment, a fan section for use in a gas turbine engine has a fan rotor with a plurality of fan blades. A plurality of exit guide vanes are positioned to be downstream of the fan rotor. The fan rotor is driven through a gear reduction. A first ratio of a number of exit guide vanes to a number of fan blades is between about 0.8 and about 2.5.

In a further embodiment according to the previous embodiment, a bypass ratio may be defined by the volume of air delivered by the fan rotor into a bypass duct compared to the volume directed to an associated compressor section. The bypass ratio is greater than about 6.

In a further embodiment according to the previous embodiments, the bypass ratio is greater than about 10.

In a further embodiment according to the previous embodiments, the first ratio is equal to or below a critical number. An acoustic feature is provided on the exit guide vanes.

In a further embodiment according to the previous embodiments, the acoustic feature is the exit guide vanes provided with at least one of optimized sweep and optimized lean.

In a further embodiment according to the previous embodiments, the exit guide vanes are provided with both optimized sweep and optimized lean.

In a further embodiment according to the previous embodiments, optimized sweep means that an outer periphery of the exit guide vanes is positioned to be downstream of a location of an inner periphery of the fan exit guide vane. A sweep angle may be greater than 0 degrees, and less than or equal to about 35 degrees.

In a further embodiment according to the previous embodiments, the sweep angle is greater than or equal to about 5 degrees.

In a further embodiment according to the previous embodiments, the sweep angle is greater than or equal to about 15 degrees.

In a further embodiment according to the previous embodiments, optimized lean means that an outer periphery of the fan exit guide vane is positioned at a greater circumferential distance than an inner periphery of the fan exit guide vane in a direction of rotation of the fan. A lean angle is greater than 0 degrees, and less than or equal to about 15 degrees.

In a further embodiment according to the previous embodiments, the lean angle is greater than or equal to about 2 degrees.

In a further embodiment according to the previous embodiments, the lean angle is greater than or equal to about 7 degrees.

In a further embodiment according to the previous embodiments, the exit guide vanes have a hollow opening. The hollow opening is covered by an acoustic liner, which is the acoustic feature.

In a further embodiment according to the previous embodiments, the liner has a micro-perforated face sheet.

In a further embodiment according to the previous embodiments, the face sheet has a thickness, and a diameter of holes in the face sheet is selected to be less than or equal to about 0.3 of the thickness.

In a further embodiment according to the immediately previous embodiment, holes in the face sheet result in at least about 5% of a surface area of the material.

In a further embodiment according to a previous embodiment, holes in the face sheet result in at least about 5% of a surface area of the material.

In another featured embodiment, a fan has a rotor with fan blades. A compression section has a first compressor section, a second compressor section, and a combustion section. A turbine section has a first turbine section associated with the first compressor section, and a second turbine section associated with the second compressor section. The first turbine section rotates at a higher speed than the second turbine section. The second turbine section drives the fan rotor and second compressor section, with a gear reduction positioned to reduce a speed of the fan rotor relative to a speed of the second compressor section. A plurality of exit guide vanes are positioned downstream of the fan rotor. A ratio of the number of exit guide vanes to the number of fan blades is below a critical value such that there is the potential for noise to be “cut-on.” The exit guide vanes are provided with an acoustic feature to address resultant sound from interaction of wakes from the fan blades across the exit guide vanes.

In a further embodiment according to the previous embodiments, the acoustic feature is the exit guide vanes having at least one of lean and sweep.

In a further embodiment according to the previous embodiments, the acoustic feature is the provision of an acoustic micro-perforated sheet.

These and other features of the invention will be better understood from the following specifications and drawings, the following of which is a brief description.

### BRIEF DESCRIPTION OF THE DRAWINGS

FIG. 1 shows a gas turbine engine.

FIG. 2A shows a detail of a fan exit guide vane.

FIG. 2B shows another view of the FIG. 2A guide vane.

FIG. 3A shows a cross-section through a guide vane.

FIG. 3B shows a portion of a material incorporated into the FIG. 3A guide vane.

FIG. 3C shows another feature of the material.

### DETAILED DESCRIPTION

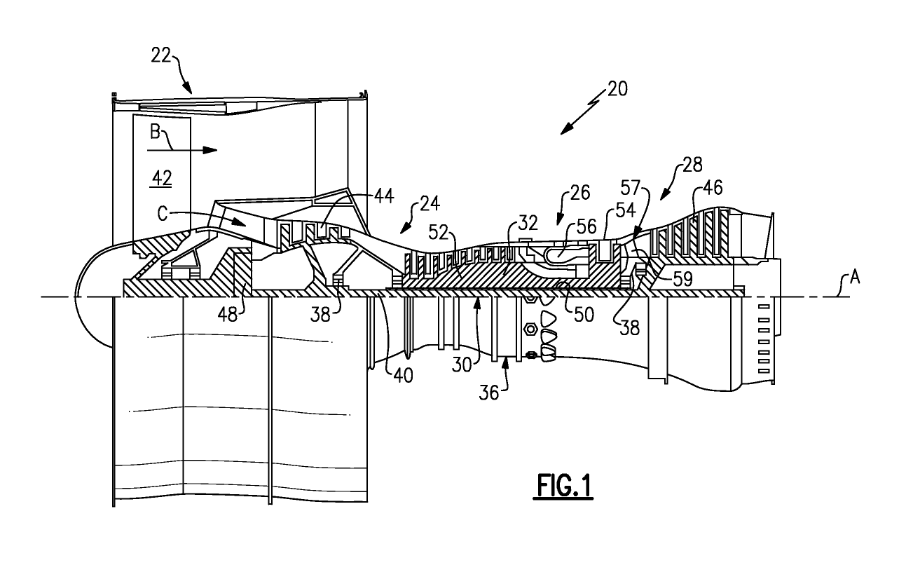

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flowpath while the compressor section 24 drives air along a core flowpath C for compression and communication into the combustor section 26 then expansion through the turbine section 28. Although depicted as a turbofan gas turbine engine in the disclosed non-limiting embodiment, it should be understood that the concepts described herein are not limited to use with turbofans as the teachings may be applied to other types of turbine engines including three-spool architectures.

The engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that interconnects a fan 42, a low pressure compressor 44 and a low pressure turbine 46. The inner shaft 40 is connected to the fan 42 through a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path. The turbines 46, 54 rotationally drive the respective low speed spool 30 and high speed spool 32 in response to the expansion.

The engine 20 in one example is a high-bypass geared aircraft engine. In a further example, the engine 20 bypass ratio is greater than about six (6), with an example embodiment being greater than ten (10), the geared architecture 48 is an epicyclic gear train, such as a planetary gear system or other gear system, with a gear reduction ratio of greater than about 2.3 and the low pressure turbine 46 has a pressure ratio that is greater than about 5. In one disclosed embodiment, the engine 20 bypass ratio is greater than about ten (10:1), the fan diameter is significantly larger than that of the low pressure compressor 44, and the low pressure turbine 46 has a pressure ratio that is greater than about 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.5:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tambient deg R)/518.7)̂0.5]. The “Low corrected fan tip speed” as disclosed herein according to one non-limiting embodiment is less than about 1150 ft/second.

A method described herein, provides an acoustically optimized count and positioning of fan exist guide vanes in the geared turbofan architecture. In the case where the vane/blade ratio is low enough to generate an additional tone noise source, i.e. a “cut-on” condition, an acoustic feature should be applied to the surface of the guide vane to mitigate the additional tone noise.

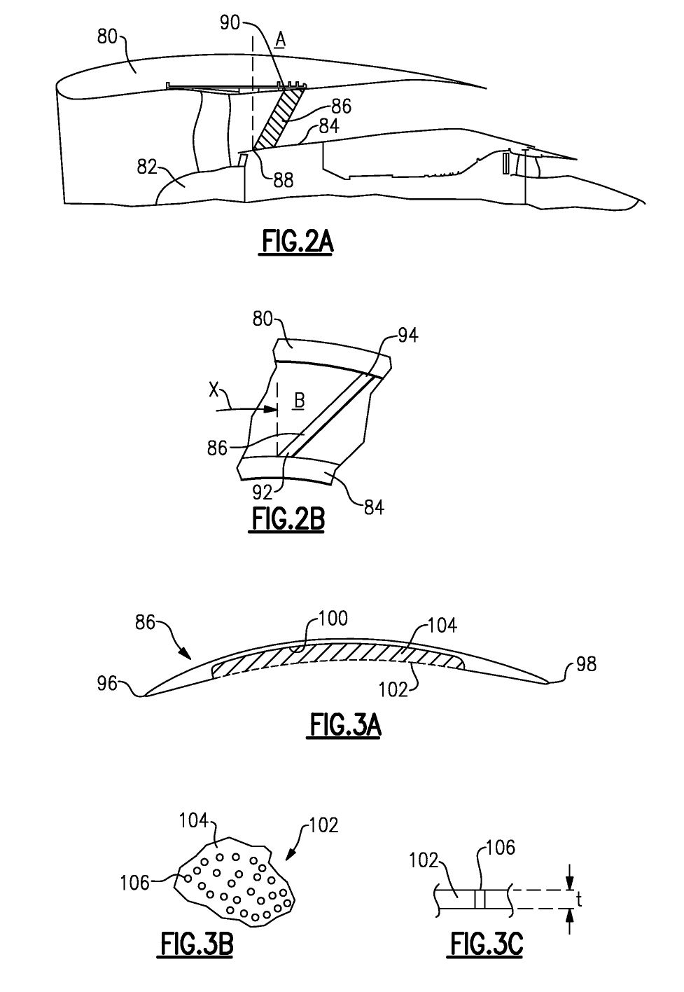

FIG. 2A shows a fan which has an exit guide vane 86 provided with any one of several noise treatment features. An outer cowl 80 is spaced outwardly of a fan rotor 82. Exit guide vanes 86 extend between an outer core housing 84 and the inner surface of the cowl 80. The guide vane 86 is actually one of several circumferentially spaced guide vanes. As mentioned above, the number of guide vanes compared to the number of rotor blades on the fan rotor control the cut-off and cut-on features of the noise produced by the fan rotor. Specifically, the ratio of guide vanes to fan blades should be between about 0.8 and about 2.5, and is described in embodiments of this disclosure.

Below some critical number the ratio can result in the noise being “cut-on”. Generally this critical number is somewhere near 2. Above the critical value, the ratio of guide vanes to fan blades may result in an overall engine that sufficiently addresses the noise on its own. Thus, engines have a ratio of guide vanes to fan blades above the critical value and provide value benefits when used in a geared turbofan engine.

When the ratio is below the critical number, however, some additional acoustic feature may be in order. Three potential acoustic features are discussed below.

In FIG. 2A, the fan exit guide vane 86 is shown to have optimized sweep. Sweep means that an inner periphery 88 of the vane is upstream of the location 90 of the outer periphery of the guide vane 86. In embodiments, the sweep angle A will be greater than 0 and less than or equal to about 35 degrees. The sweep angle A will generally be greater than or equal to about 5 degrees. In embodiments, the sweep angle A will be greater than or equal to about 15 degrees. Optimized guide vane sweep provides a reduced noise signature for the geared turbofan.

FIG. 2B shows that the vanes 86 may also be provided with optimized lean. In embodiments, a lean angle B will be greater than 0 and less than or equal to about 15 degrees. The lean angle B will generally be greater than or equal to about 2.0 degrees. In embodiments, the lean angle will be greater than or equal to about 7 degrees. As shown in FIG. 2B the vanes 86 have an outer peripheral surface 94 positioned at a greater circumferential distance from the inner periphery 92, where circumferential distance is defined in the direction of fan rotation. Optimized guide vane lean provides a reduced noise signature for the geared turbofan.

FIG. 3A shows another guide vane 86 that has an acoustic feature positioned between the leading edge 96, and the trailing edge 98 of the vane, on the pressure surface of the airfoil. The acoustic feature may be an acoustic liner as shown in FIGS. 3A-3C. The liner has a face sheet 102 over a segmented cavity 104 sitting in an opening 100 in the vane 86. Holes 106 are in face sheet 102. These holes are typically very small. As shown in FIG. 3, a thickness t of the face sheet 102 may be defined. The holes have a diameter less than or equal to about 0.3t. More narrowly, the diameter is less than or equal to 0.2t. Generally, the holes will take up at least 5% of the surface area of the material.

One micro-perforated acoustic liner may be as disclosed in U.S. Pat. No. 7,540,354B2, “Microperforated Acoustic Liner,” Jun. 2, 2009. The disclosure from this patent relating to this one example liner material is incorporated herein by reference in its entirety.

The several features mentioned above may all be utilized in combination, or each separately. In some cases, it may be desired to optimize the guide vane count and a non-zero sweep angle with 0 degrees of lean. Similarly, it may be desired to optimize the guide vane count and a non-zero lean angle with 0 degrees of sweep.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A fan section for use in a gas turbine engine comprising:
a fan rotor having a plurality of fan blades;
a plurality of exit guide vanes positioned to be downstream of said fan rotor, said fan rotor being driven through a gear reduction; and
a first ratio of a number of exit guide vanes to a number of fan blades being between about 0.8 and about 2.5.

2. The section as set forth in claim 1, wherein a bypass ratio may be defined by the volume of air delivered by said fan rotor into a bypass duct compared to the volume directed to an associated compressor section, and said bypass ratio is greater than about 6.

3. The section as set forth in claim 2, wherein said bypass ratio is greater than about 10.

4. The section as set forth in claim 1, wherein if said first ratio is equal to or below a critical number, an acoustic feature is provided on the exit guide vanes.

5. The section as set forth in claim 4, wherein said acoustic feature is the exit guide vanes being provided with at least one of optimized sweep and optimized lean.

6. The section as set forth in claim 5, wherein said exit guide vanes are provided with both optimized sweep and optimized lean.

7. The section as set forth in claim 5, wherein optimized sweep means that an outer periphery of said exit guide vanes is positioned to be downstream of a location of an inner periphery of said fan exit guide vane, and a sweep angle may be greater than 0 degrees, and less than or equal to about 35 degrees.

8. The section as set forth in claim 7, wherein said sweep angle being greater than or equal to about 5 degrees.

9. The section as set forth in claim 8, wherein said sweep angle being greater than or equal to about 15 degrees.

10. The section as set forth in claim 5, wherein optimized lean means that an outer periphery of said fan exit guide vane is positioned at a greater circumferential distance than to an inner periphery of said fan exit guide vane in a direction of rotation of said fan, and wherein a lean angle is greater than 0 degrees, and less than or equal to about 15 degrees.

11. The section as set forth in claim 10, wherein said lean angle being greater than or equal to about 2 degrees.

12. The section as set forth in claim 11, wherein said lean angle being greater than or equal to about 7 degrees.

13. The section as set forth in claim 5, wherein said exit guide vanes have a hollow opening, and said hollow opening being covered by an acoustic liner, said acoustic liner being said acoustic feature.

14. The section as set forth in claim 13, wherein said liner has a micro-perforated face sheet.

15. The section as set forth in claim 14, wherein said face sheet has a thickness, and a diameter of holes in said face sheet is selected to be less than or equal to about 0.3 of the thickness.

16. The section as set forth in claim 15, wherein holes in the face sheet result in at least about 5% of a surface area of the material.

17. The section as set forth in claim 14, wherein holes in the sheet result in at least about 5% of a surface area of the material.

18. A gas turbine engine comprising:
a fan having a rotor with fan blades;
a compression section including a first compressor section and a second compressor section;
a combustion section;
a turbine section including a first turbine section associated with said first compressor section, and a second turbine section associated with said second compressor section, and said first turbine section rotating at a higher speed than said second turbine section, and said second turbine section driving said fan rotor and said second compressor section, with a gear reduction positioned to reduce a speed of said fan rotor relative to a speed of said second compressor section;
a plurality of exit guide vanes positioned downstream of said fan rotor; and
a ratio of the number of exit guide vanes to the number of fan blades being below a critical value such that there is the potential for noise to be “cut-on” and said exit guide vanes being provided with an acoustic feature to address resultant sound from interaction of wakes from said fan blades across said exit guide vanes.

19. The gas turbine engine as set forth in claim 18, wherein said acoustic feature is said exit guide vanes have at least one of lean and sweep.

20. The gas turbine engine as set forth in claim 18, wherein said acoustic feature is the provision of an acoustic micro-perforated face sheet.
